(19) United States
(12) Patent Application Publication
(10) Pub. No.: US 2006/0167682 A1
(43) Pub. Date: Jul. 27, 2006

(54) Adaptive and progressive audio stream descrambling

(75) Inventors: Daniel Lecomte, Paris (FR); Daniela Parayre-Mitzova, Paris (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: MEDIALIVE, PARIS (FR)

(21) Appl. No.: 10/530,594

(22) PCT Filed: Oct. 21, 2003
(86) PCT No.: PCT/FR03/50098

§ 371 Date: May 19, 2005

(30) Foreign Application Priority Data
Oct. 21, 2002 (FR) 02/13090

(51) Int. Cl. G10L 19/12

(52) U.S. Cl. 704/223

(57) ABSTRACT

A process for distributing digital audio sequences in streams including data sequences containing digital audio blocks including modifying at least a part of the data sequences in an original stream to produce a modified stream in a same nominal format as the original stream, transmitting the modified stream, and reconstructing the original stream with the aid of a decoder, wherein reconstruction of the original stream is adaptive and progressive as a function of information coming from a digital profile of a target.

The present invention relates to the art of the processing of digital audio streams.

The present invention proposes supplying a system permitting the auditory scrambling and recomposing of digital audio content.

The present invention relates more particularly to a device capable of transmitting in a secure manner a set of audio streams with a high auditory quality to a musical or speech player in order to be recorded in the memory or on the hard disk of a set-top decoder box connecting the transmission network to the audio player while preserving the auditory quality but avoiding any fraudulent use such as the possibility of making pirated copies of audio programs recorded in the memory or on the hard disk of the set-top decoder box.

The invention concerns a process for the distribution of digital audio sequences according to a nominal stream format constituted by a succession of frames, each comprising at least one digital audio block grouping a certain number of coefficients corresponding to simple audio elements coded digitally according to a manner specified in the stream concerned and used by all audio decoders capable of playing it in order to be able to correctly decode it. This process comprises:

A preparatory stage consisting in modifying at least one of these coefficients,

A transmission stage

Of a main stream in conformity with the nominal format constituted by frames containing the blocks modified in the course of the preparatory stage and

By a path, separate from this main stream, of complementary digital information allowing the reconstitution of the original stream from the computation on the target equipment as a function of the main stream and of the complementary information. This complementary information is defined as a set constituted by data (e.g., coefficients describing the original data stream or extracts of the original stream) and by functions (e.g., the substitution or interchanging function). A function is defined as containing at least one instruction putting data and operators in a relationship. This complementary digital information describes the operations to be carried out for recovering the digital stream from the modified stream.

The reconstitution of the original stream is carried out on the target equipment from the modified main stream already present or sent in real time on the target equipment and from the complementary information sent in real time comprising data and functions executed with the aid of digital routines (set of instructions).

The prior art already knows a security system for portable music players from international patent application WO 0058963 (Liquid Audio). Data such as a musical track is saved as a secure portable track (SPT) that can be linked to one or several players and can be linked to a particular saving means, thus restricting the reading of the SPT to specific players and ensuring that the reading is carried out only from the original saving means. The SPT is linked to a player by the encryption of data of the SPT using a save key that is unique to the player, difficult to change and is guarded by the player under strict security conditions. The SPT is linked to a particular means of saving including data uniquely identifying the save means in a form resistant to falsification, that is, signed in an encrypted manner.

A system for scrambling audio signals is also known from U.S. Pat. No. 4,600,941 (Sony) in which an audio signal is divided into blocks, each of which is formed by a plurality of frames, which plurality of frames is rearranged on a time base in an order predetermined for each block in such a manner as to be encoded, and the encoded signal is rearranged on a time base in an original order in such a manner as to be decoded. This system comprises a first circuit for processing the signal in order to insert a redundant portion into a portion between contiguous frames and to compress the frames in base time in response to the redundant portions during the encoding, comprises a circuit generating a signal for inserting a control signal other than audio information in the redundant portions, a circuit for detecting the control signal for detecting the control signal during the decoding and a second circuit for processing the signal for removing the redundant portions in synchronism with the detected control signal and decompressing the frames in base time in response to the redundant portions.

A method and a system for scrambling and descrambling audio information signals is also known from U.S. Pat. No. 5,058,159 (Macrovision corporation). The audio signals are scrambled by inverting the original frequency spectrum in such a manner that the frequency portions that are originally at the bottom in the audio frequency band are shifted to the top whereas the portions originally at the top of the band are shifted to the bottom. A pilot sound of a known frequency is recorded with the audio signals of the shifted frequencies. During the reproduction each variation in phase and in frequency is searched by its pilot that is used to generate the modulation signal for reconstituting the original content in audio signal frequencies.

International patent application WO 99/55089 “Multimedia Adaptive Scrambling System” also teaches a system for scrambling digital samples representing multimedia data (audio and video) in such a manner that the content of the samples is degraded but recognizable or otherwise supplied with the required quality. The level of quality is linked to an associated signal/noise ratio and is determined with the aid of objective and subjective tests. A given number of LSB's (least significant bits) is scrambled frame by frame in an adaptive manner as a function of the dynamics of the possible values. All the encryption keys are included in the audio/video stream and used by the decoder for descrambling and restoring the stream. After the descrambling the encryption key cannot be recovered because it is scrambled itself by the decoder.

The state of the art gives evidence of many systems for the protection of audio streams based substantially on the encryption of data adding encryption keys independent of the content of the audio stream and which therefore modify the format of the structured stream. One particular and different realization is that of the Coding Technologies company, that consists in protecting by scrambling a selected part of the bitstream (“bitstream” refers to the binary stream at the output of the audio encoder) and not the entire bitstream. The protected parts represent the spectral values of the audio signal with the result that during the decoding without decryption the audio stream is distorted and disagreeable to the ear.

The present invention has the problem of eliminating the disadvantages of the prior art by proposing an adaptive and progressive system for descrambling the content played as a function of the profile and of the rights of the client.

In the present invention the term “scrambling” denotes the modification of a digital audio stream by appropriate methods in such a manner that that this stream remains in conformity with the norm or standard with which it was digitally encoded while rendering it audible by an audio reader (or player) but altered as concerns human auditory perception.

In the present invention the term “descrambling” denotes the process of restoration by appropriate methods of the initial stream and the restored audio stream is identical after the descrambling to the original initial audio stream. The reconstitution of the original stream is carried out on the target equipment from the modified main stream already present or sent in real time on the target equipment and from the complementary information sent in real time comprising data and functions executed with the aid of digital routines (set of instructions). The entirety or a subpart of the complementary information is sent as a function of the profile and of the rights of the client.

The quantity of information contained in this subpart of the complementary information is defined as the number of data and/or functions belonging to the complementary information sent to the target during the connection.

The type of information contained in this subpart corresponds to a level of scalability determined as a function of the profile of the target. The nature of the data and/or functions belonging to the complementary information sent to the target during the connection is defined as the type. For example, the type of data is relative to the habits of the target (connection time, duration of the connection, regularity of the connection and of payments), to his environment (lives in a big city, the time at the present moment) and to his characteristics (age, sex, religion, community).

This complementary information is composed at least by functions that are personalized for each target relative to the connection session. A session is defined starting from the connection time, the duration, the type of said modified stream listened to and the connected elements (targets, servers).

This complementary information is subdivided into at least two subparts, each of which can be distributed by different media or by the same medium. For example, in the case of distribution of the complementary information by several media a more complex management of the rights of the targets can be ensured.

The term “profile” of the user denotes a data file comprising descriptors and information specific to the user, e.g. his cultural preferences and his social and cultural characteristics, his habits of use such as the frequency of using audio means, the average listening time of a scrambled audio sequence, the frequency of listening to a scrambled sequence, the price the user is ready to pay or any other behavioral characteristic regarding the use of audio sequences. This profile is formalized by a data file or a data table that can be used by computer means.

Many scrambling systems have an immediate effect in that the initial stream is totally scrambled or the initial stream is not scrambled at all which also applies to systems for descrambling audio content. It is difficult in rigid systems of this type to satisfy the requirements of the multi-user, multi-application and multi-service client/server systems, that is, to adapt the services as a function of the various users and their rights.

The present invention has the problem of eliminating the disadvantages of the prior art by proposing an adaptive and progressive system for descrambling the content played as a function of the profile and of the rights of the client.

In the present invention an adaptive and progressive descrambling of the content listened to is applied as a function of the profile and of the rights of each user. The server sends only the subparts of said complementary information, that has a structure characterized by a “granular scalability” for supplying the target with a more or less scrambled content as a function of certain criteria, profiles and rights. The notion of “scalabilité [French]” is defined from the English word “scalability”, which characterizes an encoder capable of encoding or a decoder capable of decoding an ordered set of binary streams in such a manner as to produce or reconstitute a multilayer sequence. Granularity is defined as the quantity of information that can be transmitted per layer of a system characterized by any scalability, which system is then also granular. The granularity is relative to the degree of scrambling. The audio stream is completely scrambled once for all targets. Then, the server sends all or part of this complementary information in such a manner that the stream is played more or less scrambled by each of the targets. The sent content of this complementary information and the content played on the client player are a function of each client and the server manages and carries out the sending in real time at the moment of listening for each listener.

The invention concerns in its most general meaning a process for the distribution of digital audio sequences in the form of streams comprising data sequences containing digital audio blocks, which process comprises a stage for the modification of the original stream by modifying at least a part of these data sequences, which modification produces a modified stream in the same nominal format as the original stream. The process comprises a stage for the transmission of the modified stream and a stage for the reconstruction of the original stream with the aid of a decoder, characterized in that the reconstruction is adaptive and progressive as a function of information coming from a digital profile of the target client.

This modification preferably produces a modified main stream and complementary information that permits the reconstruction of the original stream by a descrambler, which process comprises a stage for the transmission of the modified stream and also comprises a stage for the transmission to the target equipment of a subpart of this complementary modification information, which subpart is determined as a function of information coming from a data profile of the target.

According to a variant the modified main stream is recorded on the target equipment prior to the transmission of the complementary information on the target equipment.

According to a variant the modified main stream is recorded on a physical support in order to be transmitted to the target equipment prior to the transmission of the complementary information on the target equipment.

According to another variant the modified main stream and the complementary information are transmitted together in real time at the moment of listening.

The determination of this subpart is advantageously realized by a method of granular scalability and the quantity of information contained in this subpart corresponds to a level of scalability determined as a function of the target profile.

According to a variant the type of information contained in this subpart corresponds to a level of scalability determined as a function of the target profile.

According to a particular realization this complementary modification information comprises at least one digital routine suitable for executing a function.

These functions are preferably personalized for each target as a function of the connection session.

This complementary information is advantageously subdivided into at least two subparts.

According to a variant these subparts of the complementary information are distributed by different media.

According to another variant these subparts of the complementary information are distributed by the same media.

According to a particular realization the complementary information is transmitted on a physical vector.

According to a variant the complementary information is transmitted online.

These digital sequences are advantageously in conformity with a given norm or standard.

At least a part of said client profile is preferably stored on equipment of the target.

The type of information contained in said subpart is advantageously updated as a function of the behavior of said target during the connection to the server or as a function of his habits or as a function of data communicated by a third party.

According to a variant the process comprises a prior analog/digital conversion stage with a structured format, which process is applied to an analog audio signal.

The present invention also relates to a system for the distribution of digital audio sequences comprising an audio server comprising means for broadcasting a stream modified in conformity with the previously described process and a plurality of pieces of equipment provided with a descrambling circuit, characterized in that the server also comprises means for recording the digital profile of each target and means for analyzing the profile of each of the targets of a modified stream, which means orders the nature of the complementary information transmitted to each of these analyzed targets.

According to a variant the level (quality, quantity, type) of complementary information is determined for each target as a function of the state of its profile at the moment the main stream is listened to.

The invention will be better understood with the aid of the following description made purely by way of explanation of an embodiment of the invention with reference made to the attached figure:

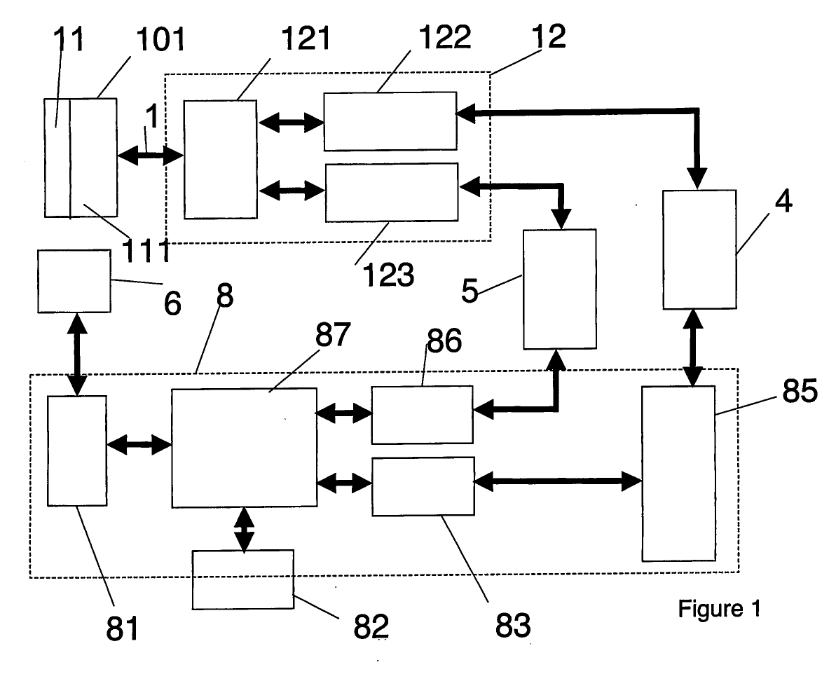

FIG. 1 shows a particular embodiment of the client-server system in accordance with the invention.

A digital audio stream is generally constituted by sequences constituted by blocks or frames organized according to a specific digital format for each audio coder. The AC-10—(advanced coding) Dolby coder performs the transformation of the time-frequency audio signal and the spectral envelope is represented in the form of exponents. A special procedure determines how many bits are to be allocated for the representation of the mantissas, that are quantified as a consequence, knowing the arrangement of these elements in the bitstream constituted by several audio blocks containing information about the dithering (digital treatment whose goal is to obtain a better approximation of a digital audio signal by adding a low-amplitude random signal), the coupling, exponents, allocation of the bits, the mantissas. The values of the exponents are coded in differential and by modifying these values very little the entire block can be corrupted and consequently the following blocks.

Our invention can consist, e.g., in a non-limiting manner in modifying the value of certain fields for an AC-3 stream, especially, e.g., the values of exponents and of mantissas whether for one or several blocks or any other elements of the stream structured in such a manner as to obtain an AC-3 stream that is perfectly in conformity but whose auditory quality is degraded and to store in complementary information organized in different layers of scalability the information necessary for a decoder for reconstituting the parts of the original stream or the integrality of the stream. When the server decides not to totally descramble the stream to be heard for a given target or when the rights of a user are insufficient for the server to send him the entire complementary information, the server can, e.g., restore only the true values of certain exponents and mantissas in such a manner that the audio stream is more or less descrambled but not the rest of the modified information.

Another example, the MPEG-AAC (MPEG—advanced audio coding) is based on the time-frequencies transformations and generates parameters of scaling and of quantification, the parameters of TNS (time noise shaping) and the parameters of LTP prediction (long time prediction). Modifying these values also produces effects of auditory disturbance. For example, the vectors of MDCT coefficients (modified direct cosine transform) are flattened by division with the LPC spectral envelope (transformed into LSP (line spectral pairs)and sent to the decoder in the form of subscripts). The weighting vectors are divided into sub-vectors that are subjected to a weighted vectorial quantification and the resulting indexes are also sent to the decoder. In the case of a vectorial quantification of the MDCT the non-uniform VQ (quantification vectors) are designated by their index in predefined tables. The MDCT are interlaced before being quantified vectorially. By modifying the index of the quantification vector or the LSP subscripts, the spectral values are modified and the error is passed on to other values as a consequence of the interlacing.

Another example: In the bitstream the spectral values are defined in the following manner:

x [g] [win] [sfb] [bin] where g indicates the group, win the spectral window used, sfb the scale factor and bin the coefficient. For example, the audio stream can be corrupted by substituting the value of [bin] by a calculated or random value. For each group the scale value is applied to all the coefficients of the group and serves to reduce the quantification noise. The elements of the bitstream for the scale factors are global_gain, scale_factor_data, hcod_sf[]. Global-gain represents the first scale factor and the point of departure for the scale factors that follow and are coded in differential relative to the preceding one with the aid of Huffinan standard tables. If the global_gain value is modified directly or replaced by a random or calculated value all the scale factors that follow will be corrupted and the audio signal will be damaged. This modification can be done for one, several groups, or for all. In the case in which the spectral values are encoded by quadruplets [w] [x] [y] [z] (in increasing order of frequency) a permutation of two values can be carried out and the spectral composition falsified, thus falsifying the indication hcod [sect_cb [g] [i] [w] [x] [y] [z] ]] which is the Huffinan code for these four values of section i of group g.

Our invention can consist, e.g., in a non-limiting manner in modifying the value of certain fields for an MPEG-AAC stream, in particular, e.g., the values of x[g] [win] [sfb] [bin], global_gain, scale_factor_data, the subscripts of the LSP index_lsp [], or interchange the spectral values [w] [x] [y] [z] whether for one or for several blocks or any other elements of the stream structured in such a manner as to obtain an MPEG-AAC stream that is perfectly in conformity but whose auditory equality is degraded and to store in complementary information organized in different layers of scalability the information necessary for a decoder to reconstitute the parts of the original stream or the integrality of the stream. When the server decides to not totally descramble the stream to be listened to for a given target or when the rights of the user are insufficient for the server to send him the totality of the complementary information, the server can e.g., restore only the true values of certain values of global_gain and of the subscripts LSP index_lsp [] in such a manner that the audio stream is more or less scrambled but not the rest of the modified information.

In the attached drawing FIG. 1 shows a preferred particular embodiment of the client-server system in conformity with the invention.

The original stream 101 can be directly in digital form 111 or in analog form 11. In the latter instance analog stream 11 is converted by a coder (not shown) into digital format 111. In the remainder of the text we will take note 1 of the input digital audio stream. The MPEG-AAC stream that is to be secured 1 is passed to an analysis and descrambling system 121 that will generate modified main stream 122 in the MPEG-AAC format identical to input stream 1 except that certain coefficients have been replaced by values different from the original ones and is placed in output buffer memory 122. Complementary information 123 of any format contains information relative to the elements of the audio blocks that were modified, replaced, substituted or moved, and their value or emplacement in the original stream.

The stream in MPEG-AAC format 122 is then transmitted either in physical form on a CD-ROM, a non-volatile memory, DVD, etc. or via a transmission network 4 of the following types: Telephone network, DSL (digital subscriber line), BLR (local radio loop), DAB (digital audio broadcasting), RTC (commutated telephone network), digital mobiles (GSM, GPRS, UMTS), microwave, cable, satellite, e.g., to the terminal of the spectator 8 and more precisely into his memory or onto his hard disk 85. When target 8 requests to hear the audio sequence present in his memory or on his hard disk 85, two possibilities are possible: either the spectator 8 does not have the rights necessary to listen to the sequence. In this case MPEG-AAC stream 122 generated by scrambling system 121 present in memory 85 is passed to synthesis system 85 via a reading buffer memory 83 that does not modify it and transmits it identically to a classic audio MPEG-AAC player 81 and its content, heavily degraded auditorily by scrambling system 121, is played on listening device 6.

Or the server decides that user 8 has the rights to hear the audio sequence, which can be tested, e.g., with the aid of a system based on a smart card 82 connected to synthesis system 87. In this case the synthesis system makes a listening request to server 12 containing the information necessary 123 for recovering the original audio stream 101. Server 12 then sends the complementary information via telecommunication networks of the following types: Analog or digital telephone line, DSL (digital subscriber line) or BLR (local radio loop), via the networks DAB (digital audio broadcasting), RTC, (commutated telephone network), or via digital telecommunication networks (GSM, GPRS, UMTS) 5, which complementary information allows the reconstitution of the audio stream 123 in such a manner that the target 8 can store it in buffer memory 86. Synthesis system 87 then proceeds to the restoration, in the scrambled MPEG-AAC stream which it reads in its reading buffer memory 83, of the modified fields whose positions it knows as well as the original values by virtue of the content of the complementary information read in buffer memory 86 for descrambling the audio. The amount of information contained in complementary information 123 that is sent to the descrambling system is specific, adaptive and progressive for each target and depends on his rights, e.g., single or multiple use, right to make one or several private copies, delayed or advance payment.

The level (quality, quantity, type) of complementary information is determined as a function of each target, as a function of the state of his profile at the moment of the transmission of the complementary stream and at least a part of this profile is stored on target equipment. For example, in FIG. 1 part of the user profile is recorded on smart card 82 connected to synthesis system 87 as, e.g., the frequency of the connections or the regularity of payments. The remainder of the profile can be on the server as, e.g., the type of music or audio clips that the spectator prefers.

Another embodiment is the updating of the target profile, which also depends on the connection time to the server (referring to the behavior) in order to know if the client connects regularly (reference to his habits) or updating as a function of recovered data close to a consumer database already existing on a server and relative to this client.

Another embodiment consists in that the server transmits all the complementary information to the target during the first minutes of listening to the audio sequence then, in the course of time, transmits less and less complimentary information to the target in such a manner as to descramble the main stream less and less, thus producing the effect for the target that the sound coming from the headset or the loudspeakers becomes more and more scrambled. This functionality can encourage the target to purchase the rights for the sequence played.

Another embodiment consists in that all or part of complementary information 123 is transmitted to the target on a physical vector such as a memory card or a smart card 82.

1-21. (canceled)

22. A process for distributing digital audio sequences in streams comprising data sequences containing digital audio blocks comprising:
modifying at least a part of the data sequences in an original stream to produce a modified stream in a same nominal format as the original stream,
transmitting the modified stream, and
reconstructing the original stream with the aid of a decoder, wherein reconstruction of the original stream is adaptive and progressive as a function of information coming from a digital profile of a target.

23. The process according to claim 22, wherein the modification produces a modified main stream and complementary information that permits reconstruction of the original stream by a decoder by transmitting the modified stream and transmitting to target equipment a subpart of the complementary modification information, which subpart is determined as a function of information coming from a data profile of the target.

24. The process according to claim 23, wherein the modified main stream is recorded or available on the target equipment prior to transmission of the complementary information on the target equipment.

25. The process according to claim 23, wherein the modified main stream is recorded on a physical support to be transmitted to the target equipment prior to the transmission of the complementary information on the target equipment.

26. The process according to claim 23, wherein the modified main stream and the complementary information are transmitted together in real time.

27. The process according to claim 23, wherein determination of the subpart is achieved by granular scalability.

28. The process according to claim 23, wherein the quantity of information contained in the subpart corresponds to a level of scalability determined as a function of the target profile.

29. The process according to claim 23, wherein the type of information contained in the subpart corresponds to a level of scalability determined as a function of the target profile.

30. The process according to claim 23, wherein the complementary modification information comprises at least one digital routine suitable for executing a function.

31. The process according to claim 30, wherein functions transmitted to each target are personalized for each target as a function of a session.

32. The process according to claim 23, wherein the complementary information is subdivided into at least two subparts.

33. The process according to claim 32, wherein the subparts of the complementary information are distributed by different media.

34. The process according to claim 32, wherein the subparts of the complementary information are distributed by the same media.

35. The process according to claim 23, wherein all or part of the complementary information is transmitted on a physical vector.

36. The process according to claim 23, wherein the complementary information is transmitted online.

37. The process according to claim 22, further comprising digital blocks in conformity with a given digital audio norm or with a standard.

38. The process according to claim 22, wherein at least a part of the profile is stored on equipment of the target.

39. The process according to claim 23, wherein the type of information contained in the subpart is updated as a function of the behavior of the target during connection to server or as a function of habits or as a function of data communicated by a third party.

40. The process according to claim 22, further comprising a prior analog/digital conversion stage with a structured format, which is applied to an analog audio signal.

41. A system for distributing digital audio sequences comprising a server including a device that broadcasts a stream modified in conformity with claim 22 and a plurality of pieces of equipment provided with a descrambling circuit, wherein the server also comprises a recorder of the digital profile of each target and an analyzer of the profile of each of the targets of a modified stream, the analyzer ordering the nature of the complementary information transmitted to each of the analyzed targets.

42. A system according to claim 41, wherein the level (quality, quantity, type) of complementary information is determined for each target as a function of the state of its profile at a moment the main stream is listened to.
